(19) United States
(12) Patent Application Publication
(10) Pub. No.: US 2007/0165590 A1
(43) Pub. Date: Jul. 19, 2007

(54) Frame Aggregation Control Parameters

(75) Inventors: Jarkko Kneckt, Espoo (FI); Mika Kasslin, Espoo (FI)

Correspondence Address: BANNER & WITCOFF, LTD., 1100 13th STREET, N.W., SUITE 1200, WASHINGTON, DC, 20005-4051, US

(73) Assignee: Nokia Corporation, Espoo (FI)

(21) Appl. No.: 11/622,120

(22) Filed: Jan. 11, 2007

Related U.S. Application Data
(60) Provisional application No. 60/758,558, filed on Jan. 13, 2006.

(51) Int. Cl. H04J 3/00

(52) U.S. Cl. 370/345

(57) ABSTRACT

A method and system for defining a transmission of data within a transmission opportunity (TXOP) is described. Aspects of the present system and method are related to wireless local area network (WLAN) systems. In one embodiment, aspects of the present system may be utilized within a WLAN system operating in accordance with frame aggregation mechanisms. Other aspects of the system specify the role of access point (AP) and non-AP stations operating in a bidirectional single receiver aggregation procedure. Aspects of the described system and method provide control to an AP or other station to limit the duration of the response burst, including acknowledgement message, aggregated with one or more data frames. Other aspects indicate how bidirectional single receiver aggregate data flow should be used in infrastructure, mesh and ad hoc operation scenarios.

This application claims priority to provisional U.S. Application No. 60/758,558, filed Jan. 13, 2006, the contents of which being bodily incorporated by reference in its entirety.

### FIELD OF THE INVENTION

The present invention relates generally to wireless local area network (WLAN) systems. More specifically, the present invention relates to defining enhanced distributed channel access (EDCA) control parameters for frame aggregation.

### BACKGROUND

Wireless communication technology has quickly become a mainstay in the homes and offices of many people. With the surging popularity of wireless technology for accessing the Internet and local area networks (LANs), the need for standard protocols and communications procedures has increased. With many manufacturers competing for the same clientele, a standard defining the protocol and compatible interconnection of data communication equipment via the air in a LAN using the carrier sense multiple access protocol with collision avoidance (CSMA/CA) medium sharing mechanism was created. This standard is known in the industry as the Institute of Electrical and Electronics Engineers (IEEE) 802.11 standard, 1III std. 802.11-1997.

Various industry standards have been finalized and adopted under IEEE Std. 802.11. For example, 802.11a, 802.11b, and 802.11g are three such standards for wireless-fidelity (Wi-Fi) networking.

The fairness and efficiency of the radio spectrum usage has been studied heavily in 802.11e quality of service (QoS) amendment for IEEE Std. 802.11. The QoS amendment defines many new principles to create priority separation for applications and it changes the mechanism for how terminals transmit. The evolution of the QoS principles has been continued in the 802.11n high throughput task group. The 802.11n task group is creating an amendment for the Std. 802.11 that allows more efficient data transmission over the air by utilizing multiple wireless antennas in tandem to transmit and receive data. The 802.11n standard is being developed to include an increased channel bandwidth as well.

The 802.11n standard defines mechanisms to increase data transmission efficiency by increasing the size of the aggregated frames. The data aggregation creates the possibility to have a burst of data frames transmitted in which all can be acknowledged with a single block acknowledgement frame. For frame aggregation the WLAN radio may use aggregated medium access control protocol data units (A-MPDU), aggregated medium access control service data units (A-MSDU), aggregated medium access control protocol data units (A-PPDU), or similar mechanism to aggregate several frames into a transmitted burst of packets, i.e., set of packets, transmitted by a radio. A burst of packets may contain short periods between aggregated frames.

In the single receiver data flows, the burst of data is transmitted from one node to another node. The multi receiver data flow starts when the burst of data is transmitted from a node to several recipients. After this data transmission, the receivers transmit burst of frames back to the original transmitter. The data flows may also have other forms, which are described in more details below.

Another standard currently in development is the 802.11s standard. The 802.11s standard is designed to create a Wireless Mesh Network with basic 802.11 technology. The mesh technology allows the creation of a Wi-Fi network with access points (APs) that are connected wirelessly. Thus, the nodes closer to the Internet backbone will forward over the air the traffic for APs further away from the Internet.

Data is transmitted over IEEE Std. 802.11 wireless networks in frames. A frame includes a discrete portion of data along with some descriptive meta-information packaged for transmission on a wireless network. Each frame includes a source and destination medium access control (MAC) address, a control field with protocol version, a frame type, a frame sequence number, a frame body with the actual information to be transmitted, and a frame check sequence for error detection.

The 802.11 standard defines various frame types for management and control of the wireless infrastructure, and for data transmission. The 802.11 frame types are management frames, control frames, and data frames. Management frames may have higher priority for transmission.

The transmission opportunity (TXOP) is an interval of time when a client station operating according to Wi-Fi multimedia has the right to initiate transmissions onto a wireless medium (WM). AP enhanced distributed channel access (EDCA) parameters affect traffic flowing from the AP to a client station, e.g., a terminal.

Both AP and terminals have their own EDCA parameters. Many EDCA parameters, such as minimum contention window (CWmin), maximum contention window (CWmax), and arbitrary interframe spacing number (AIFSN) values, affect the probability of the TXOP. These parameters may be set differently for different application types, e.g., voice over Internet protocol (VoIP), transmission control protocol (TCP) data, etc.

The current EDCA parameters only define the maximum duration of the transmission opportunity (TXOP) in the TXOPLimit parameter. The TXOPLimit parameter controls the maximum duration of the obtained TXOP. The TXOP has only a single owner, who may transmit to other radios. If the maximum duration of the TXOP is not reached, the owner of the TXOP may transmit more frames to the same or other receivers during the TXOP.

When a WLAN radio receives data frames, it may transmit an acknowledgement frame to acknowledge the received data. If the receiving node only acknowledges the received data, the data flow may be called unidirectional. If the receiving node transmits acknowledgement and some other frame(s) in burst of packets as a response to a TXOP owner, the data flow may be called bidirectional aggregation.

The current EDCA parameters have no ability to control the maximum duration of the burst of aggregated acknowledgement and data frame(s) transmission as a response for a TXOP owner transmission. Thus, the AP has no control over the duration of the responder's burst of packets. A limitation for maximum duration of the responder's burst of packets is needed in order to guarantee fairness among various terminals and to allow APs to control the transmissions in the network.

The bidirectional aggregation transmission time controlling is a problem for mesh networks, where the nodes that form mesh network need to forward the traffic over the air for the other nodes. The amount of forwarded traffic is often larger than a single terminal is able to handle. Thus, the controlling of the responder burst size is needed for mesh network control. Currently the TXOPLimit parameter is the only limitation for the TXOP duration.

### SUMMARY

This Summary is provided to introduce a selection of concepts in a simplified form that are further described below in the Detailed Description. The Summary is not intended to identify key features or essential features of the claimed subject matter, nor is it intended to be used to limit the scope of the claimed subject matter.

Aspects of the present invention are related to wireless local area network (WLAN) systems. In one embodiment, aspects of the present invention may be utilized within a WLAN system operating in accordance with the IEEE 802.11 standards, such as 802.11n or 802.11s standards. However, it should be understood by those skilled in the art that aspects of the present invention may be utilized in other protocol standards and that the present invention is not so limited to any one standard.

Aspects of the invention include bidirectional data flows, which may be implemented as one or more EDCA control parameters for a bidirectional single receiver aggregate mechanism. Other aspects of the invention specify the role of access point (AP) and non-AP stations operating in a bidirectional single receiver aggregation procedure. According in the Std. 802.11, an AP is any entity that has station functionality and provides access to distribution services, via a wireless medium (WM) for associated stations, and a station (STA) is any device that contains an IEEE 802.11 conformant medium access control (MAC) and physical layer (PHY) interface to the wireless medium (WM). As such, a non-AP STA is a device which does not provide other devices access to the distribution services. Aspects of the invention provide a quality of service (QoS) definition for a bidirectional single receiver aggregation mechanism, which may be used in infrastructure, ad hoc, and mesh networks.

In accordance with aspects of the present invention, in an infrastructure network an access point (AP) or other station in control can set a maximum duration for the non-AP STAs' response bursts duration inside a TXOP. According in the Std. 802.11e, a TXOP is an interval of time when a particular QSTA has the right to initiate frame exchange sequences onto a wireless medium (WM). A TXOP is defined by a starting time. Aspects of the present invention limit the duration of the burst/frame sent from the STA which has obtained the TXOP. Aspects of the present invention limit the length of the data transmission. As used herein, length refers to time slots which are used as a basic unit depending on the physical layer used in IEEE Std. 802.11. Aspects of the present invention limit the occupancy of the wireless medium.

A response burst may contain responding ack (or block-ack) message that may be aggregated with one or more frames, whether data frames or other types. This may be accomplished by introducing a new EDCA parameter referred to herein as a ResponderBurstLimit parameter. The EDCA parameters define a set of parameters for different Access Categories (AC). An AC characterizes the priority level of the transmitted data. IEEE Std. 802.11e defines four ACs referred to as background, best effort, streaming, and VoIP. An AP may define different EDCA parameters for each AC.

In infrastructure operation mode, the non-AP STA and AP have different EDCA parameters. The AP defines the EDCA parameters for non-AP STAs and signals the EDCA parameter values to the non-AP STAs. The non-AP STAs do not know the EDCA parameters of the AP and thus the AP may decide not to use responder burst limit if it is responder. The AP may transmit longer response bursts and exceed even the TXOPLimit value in responses.

In ad hoc operation mode, all STAs are non AP STAs. All STAs in ad hoc mode appreciate the EDCA parameter values. In mesh operation mode, the nodes follow EDCA parameters for their transmissions.

In accordance with one embodiment, a device is configured to examine data traffic and network congestion to determine a ResponderBurstLimit parameter value. Another device may be configured to receive the ResponderBurstLimit parameter value and to apply it for aggregated response frames.

The limitation possibility of the duration of the responder's burst of frames is not dependent upon the mechanism for how the TXOP was obtained. A similar mechanism operates also for HCCA or similar principles.

The TXOPLimit defines the maximum duration for a TXOP. The maximum duration of the responder's burst of packets shall not exceed the TXOPLimit duration. The responder burst of frames maximum duration shall be limited by the TXOP owner's (i.e. previously received frame's) Mac header duration field value (i.e. NAV rules are applied) and the value of ResponderBurstLimit value. The responder may send a burst of frames that is shorter than the maximum duration. If the same radio is the responder several times in a TXOP, each response burst of frames maximum duration is limited by the ResponderBurstLimit.

### BRIEF DESCRIPTION OF THE DRAWINGS

The foregoing summary of the invention, as well as the following detailed description of illustrative embodiments, is better understood when read in conjunction with the accompanying drawings, which are included by way of example, and not by way of limitation with regard to the claimed invention.

FIG. 1 is a block diagram illustrating an example of a transmission within a time scale in accordance with at least one aspect of the present invention;

FIG. 2 is a block diagram illustrating an example of a system for defining transmission parameters in accordance with at least one aspect of the present invention; and

FIG. 3 is a flowchart of an illustrative method for applying a transmission parameter to subsequent transmissions of data in accordance with at least one aspect of the present invention.

### DETAILED DESCRIPTION

In the following description of the various embodiments, reference is made to the accompanying drawings, which form a part hereof, and in which is shown by way of illustration various embodiments in which the invention may be practiced. It is to be understood that other embodiments may be utilized and structural and functional modifications may be made without departing from the scope of the present invention.

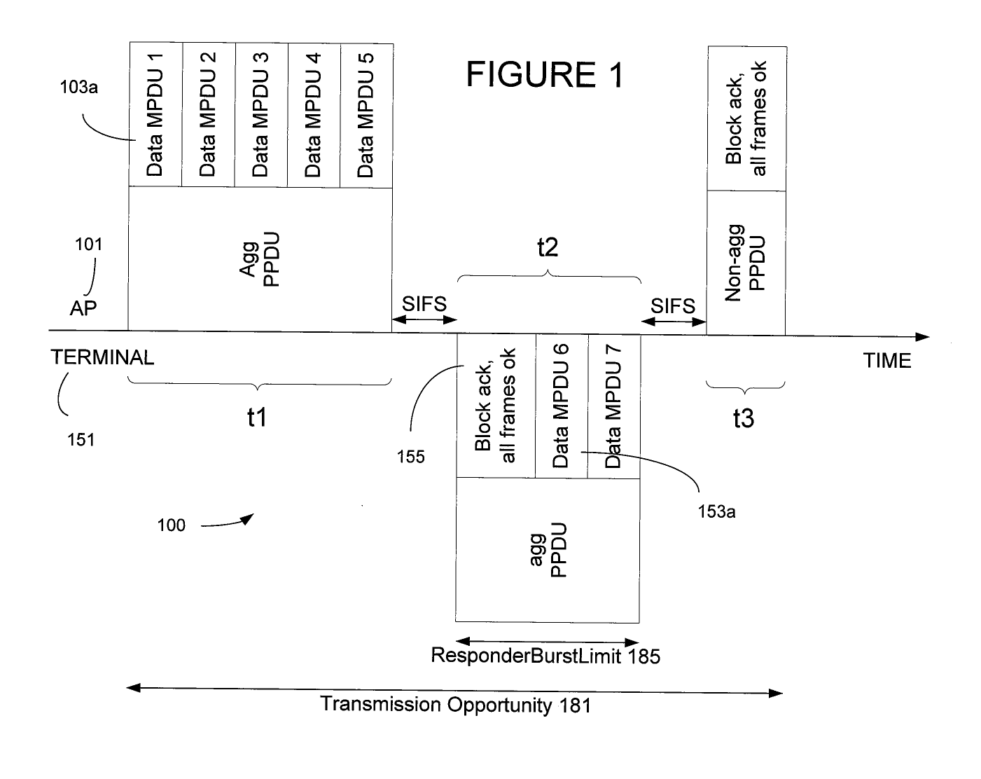

FIG. 1 is a block diagram illustrating an example of a transmission within a time scale in accordance with at least one aspect of the present invention. In accordance with at least one aspect of the present invention, a responder burst duration is controlled. One illustrative manner for controlling a responder burst duration is by introduction of a new EDCA parameter. As used herein, the new EDCA parameter is referred to as ResponderBurstLimit parameter. EDCA parameters are defined in the 802.11e QoS amendment to the 802.11 standard. The ResponderBurstLimit parameter is an access category (AC) specific parameter. Specifically, the ResponderBurstLimit parameter specifies a maximum duration for an acknowledgement and data transmission aggregation frame transmitted by a responder. FIG. 1 illustrates an example of the ResponderBurstLimit parameter in use. The data aggregation schema in the figure may use A-PPDU, A-MSDU or A-MPDU aggregation mechanisms, which are not clearly shown in the figure. Similarly the block acknowledgement mechanism may use Block Ack Request (BAR) frames. As should be understood by those skilled in the art, in accordance with at least one aspect of the present invention, a responder burst duration, such as a ResponderBurstLimit parameter, may have a default value that may be systematically changed and/or user reconfigurable as needed for a particular application.

A ResponderBurstLimit parameter may be specified for non-AP stations and access points (APs). Non-AP stations may limit the maximum acknowledgement and data respond burst duration according to the ResponderBurstLimit parameter value. An access point (AP) need not describe its EDCA parameters to a non-AP station, so it may have a larger ResponderBurstLimit parameter value.

For transmission opportunities (TXOPs) which are started by non-AP stations, e.g., a terminal, the TXOPLimit parameter limits only the duration of the frames transmitted by the non-AP station. The AP may transmit acknowledgement and data frames which may exceed the duration of the TXOPLimit parameter. The ResponderBurstLimit parameter of an AP may specify the maximum duration for the response frame on the AP. The AP may set the duration field after its own acknowledgement and data burst transmission to a larger value than a used transmission time allows.

Aspects of the present invention enables more control to access points (APs) to control channel use and simplifies the EDCA rules for bidirectional single receiver capable APs and non-AP stations.

A ResponderBurstLimit value may be provided to an STA in management frames in accordance with IEEE Std. 802.11. Examples of management frames include beacons, probe requests/responses, association requests/responses, and reassociation requests/responses. In infrastructure operation mode, the non-AP STA and AP have different EDCA parameters. The AP defines the EDCA parameters for non-AP STAs and signals the EDCA parameter values to the non-AP STAs. The non-AP STAs do not know the EDCA parameters of the AP and thus the AP may decide not to use responder burst limit if it is the responder. The AP may transmit longer response bursts and exceed even the TXOPLimit value in responses. EDCA parameters may be delivered using management frames of IEEE Std. 802.11.

In ad hoc operation mode, all STAs are non AP STAs. All STAs in ad hoc mode appreciate the EDCA parameter values. In ad hoc mode, a burst duration, such as a ResponderBurstLimit, may be a default parameter in the STA. In mesh operation mode, the nodes follow EDCA parameters for their transmissions. A burst limit parameter may be Access Category (AC) specific and may be added in the record field for each AC separately.

As seen in the example transmission 100 shown in FIG. 1, during a transmission opportunity 181, an AP 101 may transmit an aggregated protocol data unit (Agg PPDU) including medium access control protocol data units (MPDU), such as 103a, during a first time period t1.

After waiting the short inter-frame spacing time (SIFS) period, a non-AP station, e.g., terminal 151, may transmit an aggregated protocol data unit (Agg PPDU) including a responding acknowledgement message 155 aggregated with one or more additional data frames, such as MPDU 153a, during a second time period t2. The response frames of the terminal 151 are transmitted in accordance with a ResponderBurstLimit parameter 185.

After waiting another short inter-frame spacing time (SIFS) period, the AP 101 may transmit a non-aggregated protocol data unit (Non-agg PPDU) including a responding acknowledgement message during a third time period t3.

In mesh networks, the frame aggregation mechanisms may control the responder acknowledgement and data aggregation transmission time duration. A ResponderBurstLimit parameter may be used to create fairness and to allow control to an owner of the TXOP.

In accordance with one embodiment, a definition for the standard may be established so that the value of a ResponderBurstLimit parameter is 2 octets long, specified as an unsigned integer, with the least significant octet transmitted first, in units of 32 microseconds. A ResponderBurstLimit parameter value of 0 may indicate that the TXOP is unidirectional and the responder responds only with a (block) acknowledgement frame. If the value of ResponderBurstLimit is less than the time to transmit acknowledgement or block acknowledgement frame, the plain (block) acknowledgement frame may be transmitted. In another example, a ResponderBurstLimit value of 1 may indicate a ResponderBurstLimit of 32 microseconds and a ResponderBurstLimit value of 2 may indicate a ResponderBurstLimit of 64 microseconds.

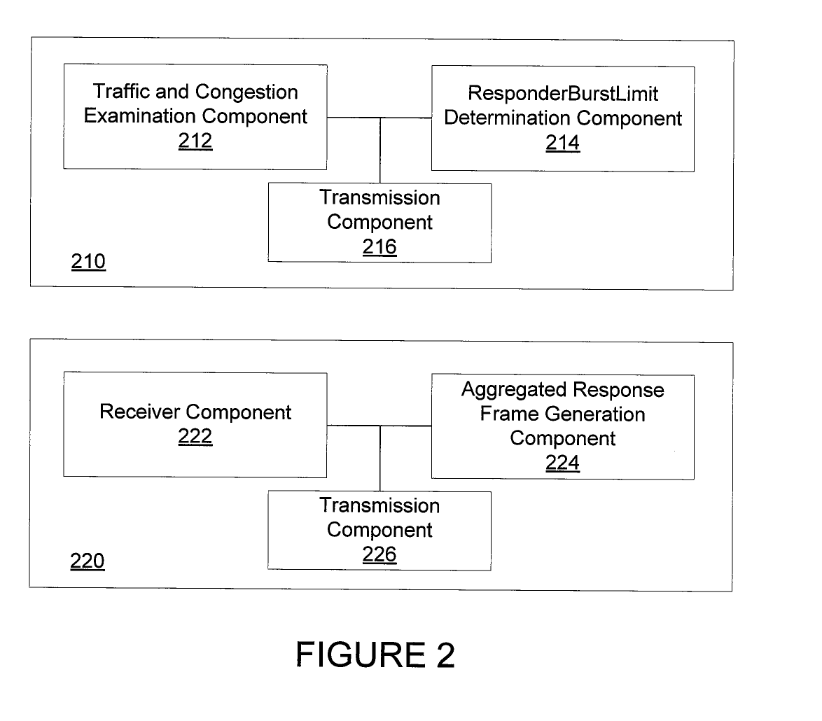

FIG. 2 is a block diagram illustrating an example of a system for defining transmission parameters in accordance with at least one aspect of the present invention. FIG. 2 shows a first device 210 that may be configured to examine data traffic and network congestion conditions in order to determine a ResponderBurstLimit parameter.

First device 210 may include a traffic and congestion examination component 212 configured to receive and examine data traffic and network congestion information. Operatively connected to component 212 is a ResponderBurstLimit determination component 214. ResponderBurstLimit determination component 214 may be configured to determine an appropriate value for the ResponderBurstLimit parameter for response frames during a transmission opportunity (TXOP). The ResponderBurstLimit parameter may specify the maximum acknowledgement and data respond burst duration for a second device(s) 220. EDCA parameters may be given through network control protocol, for instance control and provisioning of wireless access points (CAPWAP), to infrastructure APs, or they may be manually configured. The changed EDCA parameters may be delivered for instance in periodical beacon transmissions. For example, in systems operating according to IEEE 802.11, the EDCA parameters may be delivered in management frames such as beacons, probe requests/responses, association requests/responses and reassociation requests/responses, to name a few possibilities.

Operatively connected to the ResponderBurstLimit determination component 214 and the traffic and congestion examination component 212 is a transmission component 216. Transmission component 216 may be configured to transmit the determined ResponderBurstLimit parameter value to a second device 220.

Second device 220 may be configured to receive a ResponderBurstLimit parameter value and apply the ResponderBurstLimit parameter value to subsequent transmissions. Second device 220 may include a receiver component 222 that may be configured to receive a ResponderBurstLimit parameter value from another device, such as first device 210. As described above, the ResponderBurstLimit parameter may specify the maximum acknowledgement and data respond burst duration for the second device 220.

An aggregated response frame generation component 224 is operatively connected to the receiver component 222. Aggregated response frame generation component 224 may be configured to apply the received determined ResponderBurstLimit parameter value to aggregated response frames and to generate the aggregated response frames, each including a response acknowledgement message aggregated with one or more data frames. A transmission component 226 may be operatively connected to the receiver component 222 and the aggregated response frame generation component 224. Transmission component 226 may be configured to transmit the aggregated response frames that are based upon the ResponderBurstLimit parameter value. It should be understood by those skilled in the art that one or more aspects of the present invention may be implemented in 802.11n single receiver bidirectional aggregation compatible devices. The devices may apply different logics to define EDCA parameter values depending on their network operation mode, mesh infrastructure or in ad hoc operation modes.

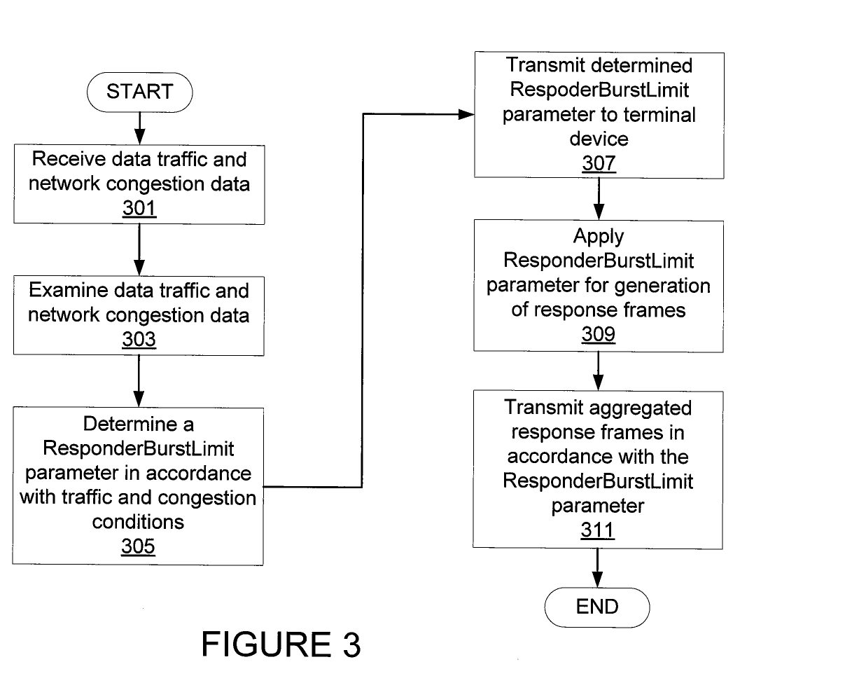

FIG. 3 is a flowchart of an illustrative method for applying a transmission parameter to subsequent transmissions of data in accordance with at least one aspect of the present invention. The method starts at step 301 where data traffic and network congestion data is received. At step 303, the received data traffic and network congestion data is examined. Proceeding to step 305, a ResponderBurstLimit parameter value is determined in accordance with the traffic and congestion conditions. The ResponderBurstLimit parameter value allows an access point (AP) to gain additional control over use of a transmission channel.

Moving to step 307, the determined ResponderBurstLimit parameter value is transmitted to a terminal device in communication with an AP. At step 309, the ResponderBurstLimit parameter value is received and applied for generation of response frames. Finally, at step 311, aggregated response frames are transmitted in accordance with the ResponderBurstLimit parameter value.

While illustrative systems and methods as described herein embodying various aspects of the present invention are shown, it will be understood by those skilled in the art, that the invention is not limited to these embodiments. Modifications may be made by those skilled in the art, particularly in light of the foregoing teachings. For example, each of the elements of the aforementioned embodiments may be utilized alone or in combination or subcombination with elements of the other embodiments. It will also be appreciated and understood that modifications may be made without departing from the true spirit and scope of the present invention. The description is thus to be regarded as illustrative instead of restrictive on the present invention.

We claim:

1. A method comprising:
examining data representative of data traffic and network congestion;
determining a respond burst duration value of a device in accordance with the examined data; and
transmitting data representative of the respond burst duration value to the device.

2. The method of claim 1, wherein the respond burst duration value corresponds to a maximum acknowledgement and data respond burst duration for the device.

3. The method of claim 1, wherein the respond burst duration value is a default value that is configured to be changed.

4. The method of claim 3, wherein the respond burst duration value is configured to be changed by a user.

5. The method of claim 1, wherein the device is an access point.

6. The method of claim 1, wherein transmitting data representative of the respond burst duration value occurs at a terminal.

7. The method of claim 6, wherein the terminal is a non-access point device.

8. A method comprising:
receiving data representative of a respond burst duration value for a device;
applying the respond burst duration value to generate an aggregated response frame, including a response acknowledgement message aggregated with at least one data frame; and
transmitting the aggregated response frame to another device.

9. The method of claim 8, wherein the respond burst duration value corresponds to a maximum acknowledgement and data respond burst duration for the device.

10. The method of claim 8, wherein the device is a terminal.

11. The method of claim 10, wherein the terminal is a non-access point device.

12. The method of claim 8, wherein the another device is an access point.

13. A device comprising:
an examination component configured to receive data representative of data traffic and network congestion and to examine the received data;
a determination component configured to determine a respond burst duration value of a wireless device in accordance with the received and examined data; and
a transmission component configured to transmit data representative of the respond burst duration value to a wireless device.

14. The device of claim 13, wherein the respond burst duration value corresponds to a maximum acknowledgement and data respond burst duration for the wireless device.

15. The device of claim 13, wherein the respond burst duration value is a default value that is configured to be changed.

16. The device of claim 15, wherein the respond burst duration value is configured to be changed by a user.

17. A wireless device comprising:
a receiver component configured to receive data representative of a respond burst duration value for the wireless device;
an aggregated response frame generation component configured to apply the respond burst duration value to generation of an aggregated response frame and to generate the aggregated response frame, the aggregated response frame including a response acknowledgement message aggregated with at least one data frame; and
a transmission component configured to transmit the aggregated response frame to another device.

18. The wireless device of claim 17, wherein the respond burst duration value corresponds to a maximum acknowledgement and data respond burst duration for the device.

19. The method of claim 17, wherein the another device is an access point.

20. A device comprising:
means for receiving data representative of data traffic and network congestion;
means for examining the data;
means determining a respond burst duration value of a wireless device in accordance with the examined data; and
means for transmitting data representative of the respond burst duration value to the wireless device.

21. The device of claim 20, wherein the respond burst duration value corresponds to a maximum acknowledgement and data respond burst duration for the wireless device.

22. A device comprising:
means for receiving data representative of a respond burst duration value for the device;
means for applying the respond burst duration value to generation of an aggregated response frame;
means for generating the aggregated response frame, the aggregated response frame including a response acknowledgement message aggregated with at least one data frame; and
means for transmitting the aggregated response frame to another device.

23. The device of claim 22, wherein the respond burst duration value corresponds to a maximum acknowledgement and data respond burst duration for the device.
